(19) United States
(12) Patent Application Publication
(10) Pub. No.: US 2002/0139036 A1
(43) Pub. Date: Oct. 3, 2002

(54) Combination carrier for a fishing rod and reel and fishing tackle

(76) Inventor: Montgomery A. Smith, Westminster, CO (US)

Correspondence Address: EDWIN H. CRABTREE, Suite 575, 3773 CHERRY CREEK N. DR., DENVER, CO, 80209, US

(21) Appl. No.: 09/822,078

(22) Filed: Apr. 2, 2001

(51) Int. Cl. A01K 97/10

(52) U.S. Cl. 43/21.2

(57) ABSTRACT

A combination carrier used for holding a fishing rod and reel and fishing tackle. The combination carrier is made of lightweight, heavy duty fabric with padding therein. The carrier can be carried by hand or held on a shoulder using a hand and shoulder strap when fishing. The carrier provides for quick access to a variety of fishing equipment supplies. The combination carrier includes a flexible carrier member having a front cover integrally attached to a lower fold portion. The lower fold portion is integrally attached to a rear cover. The front cover, when folded upwardly on the fold portion and indexed with the rear cover, is releasably attached to the rear cover using hook and loop fasteners. The hook and loop fasteners are disposed along the length of three sides of the front and rear covers. The front and rear covers include a plurality of pockets inside and outside for holding fishing tackle. The lower fold portion is used for receiving and holding the fishing rod and reel in a nesting relationship when the front cover is attached to the rear cover. The combination carrier also includes an adjustable hand and shoulder strap with ends attached to a top portion of the rear cover.

### BACKGROUND OF THE INVENTION

(a) Field of the Invention

This invention relates to fishing equipment and more particularly, but not by way of limitation, to a combination carrier for holding a fishing rod and reel and fishing tackle. The carrier can be hand held or carried on a shoulder. The combination carrier providing quick access to fish bait, fish lures and related fishing supplies when stream fishing, lake fishing and at other fishing locations.

(b) Discussion of Prior Art

Heretofore, there have been a variety of different types of fishing rod and reel holders and carriers along with various types of fishing tackle boxes and containers. None of prior art fishing rod and reel holders and fishing tackle boxes provide the unique features, structure and function of the subject combination carrier for holding both a fishing rod and reel and fishing tackle.

### SUMMARY OF THE INVENTION

In view of the foregoing, it is a primary objective of the subject invention to provide a carrier that will hold both a fishing rod and reel and fishing tackle when transporting fishing equipment to and from a fishing location and for holding the fishing tackle in front of a fisherman's body or next to his/her side while fishing.

Another object of the combination carrier is to provide a quick access to various types of fish bait, fish lures and other fishing supplies.

Yet another object of the invention is the carrier is made of lightweight, heavy duty fabric with padding for ease in transporting and comfort when carrying the carrier by hand or holding it next to the body when in use. The carrier also includes a plurality of different sizes and shapes of pockets for holding a variety of fishing supplies and miscellaneous items.

Still another object of the invention is the carrier includes an adjustable hand and shoulder strap which can be adjusted for holding the carrier by hand or adjusted for receipt over a shoulder and holding the carrier next to the front or side of the body.

A further object of the carrier is the use of a removable rod bag which is releasable attached to a portion of the carrier. The rod bag is used for holding a portion of an outwardly extending rod when transporting the rod and reel to and from a fishing location.

The combination carrier includes a flexible carrier member. The carrier member has a front cover integrally attached to a lower fold portion. The lower fold portion is integrally attached to a rear cover. The front cover, when folded upwardly on the fold portion, can be indexed with the rear cover and releasably attached to the rear cover using hook and loop fasteners. The hook and loop fasteners are disposed along a length of three sides of the front and rear covers. The front and rear covers include a plurality of pockets inside and out for holding fishing tackle. The lower fold portion of the carrier member is used for receiving and holding the fishing rod and reel in a nesting relationship when the front cover is attached to the rear cover. The reel is nested between a pair of pockets attached to the inside of the rear cover. The combination carrier also includes an adjustable hand and shoulder strap with ends of the strap attached to a top portion of the rear cover.

These and other objects of the present invention will become apparent to those familiar with fishing rod and reel carriers and cases and various types of fishing tackle boxes when reviewing the following detailed description, showing novel construction, combination, and elements as herein described, and more particularly defined by the claims, it being understood that changes in the embodiments to the herein disclosed invention are meant to be included as coming within the scope of the claims, except insofar as they may be precluded by the prior art.

### BRIEF DESCRIPTION OF THE DRAWINGS

The accompanying drawings illustrate complete preferred embodiments in the present invention according to the best modes presently devised for the practical application of the principles thereof, and in which:

FIG. 1 is a perspective view of the subject combination carrier with a carrier member having a front cover indexed with and releasably attached to a rear cover using hook and loop fasteners. An outside of the front cover is shown having a plurality of pockets for quick access to fish bait and other fishing supplies.

FIG. 1A is another perspective view of the combination carrier with a hand and shoulder strap adjusted for receipt over a shoulder of a fisherman. The fisherman is shown fishing in a mountain stream.

FIG. 2 is still another perspective view of the carrier with the carrier member in an open position with the front cover unfolded from the rear cover and illustrating a telescoping rod and real received on top of a fold portion integrally formed between the front and rear covers.

FIG. 3 illustrates a perspective view of the back of the rear cover with the front cover releaseably attached to the rear cover.

FIG. 4 is another perspective view of the carrier member with a removable rod bag releaseably attached to a portion of the front and rear covers. The rod bag is used for receiving a portion of an extended fishing rod therein. The bag is used when transporting the extended fishing rod to and from a fishing location.

### DESCRIPTION OF THE PREFERRED EMBODIMENTS

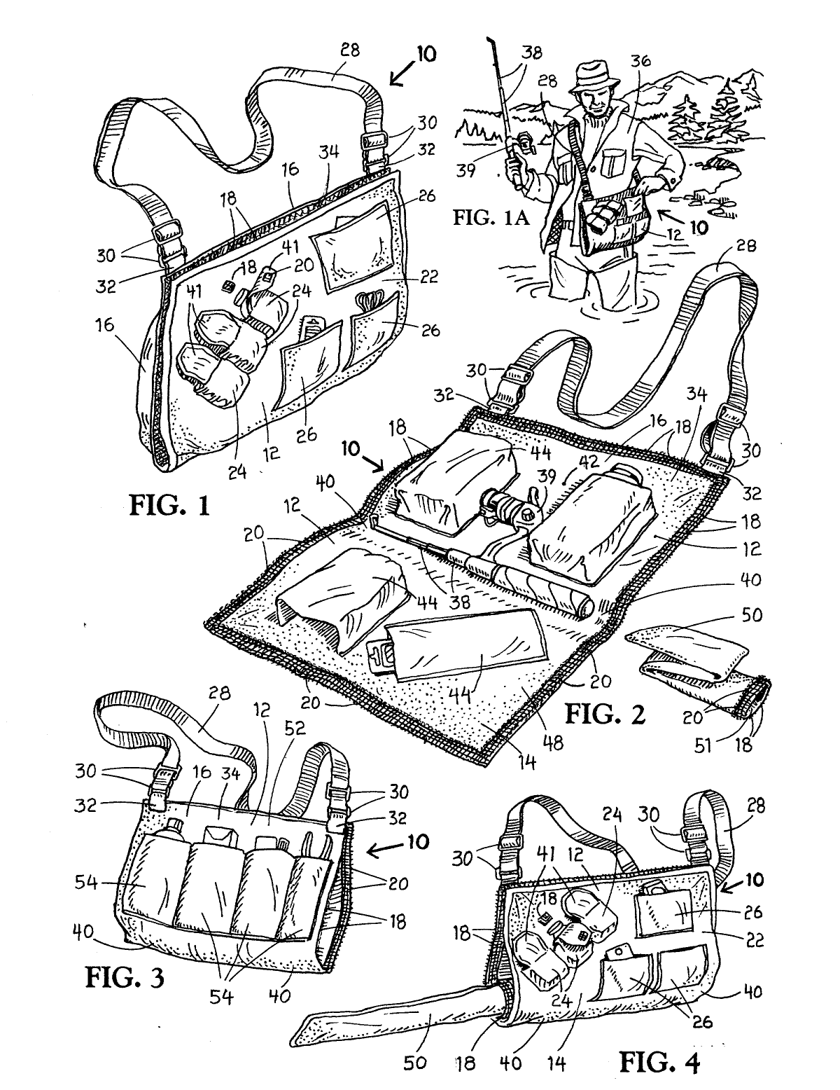

In FIG. 1, a perspective view of the subject combination carrier is illustrated and having a general reference numeral 10. The combination carrier 10 broadly includes a carrier member 12 having a front cover 14 indexed with and attached to a rear cover 16 using strips of hook fasteners 18 releaseably secured to strips of loop fasteners 20. An outside 22 of the front cover 14 is shown having a plurality of angled pockets 24 with the open top of the angled pockets at an angle from the horizontal for quick access to fish bait containers. Also shown in this drawing are a plurality of supply pockets 26 for holding other fishing supplies such as a stringer, hooks and swivels, fishing license, etc. The open tops of the supply pockets 26 are parallel with the horizontal when the combination carrier 10 is held in an upright position as shown in this drawing.

The carrier 10 also includes a hand and shoulder strap 28 having strap loop rings 30 which are used to adjust and shorten the strap 28 for holding the carrier by hand. Also, the strap 28 can be lengthened for receipt over a shoulder and holding the carrier member 12 next to the front and side of the body. Opposite ends 32 of the hand and shoulder strap 28 are attached to a top portion 34 of the rear cover 16.

In FIG. 1A, another perspective view of the combination carrier 10 is shown with the hand and shoulder strap 28 adjusted for receipt over a shoulder of a fisherman 36 shown fishing in a mountain stream. Note the strap 28 is received over the fisherman's right shoulder with the carrier member 12 resting comfortably next to the front and left side of the fisherman 36. The inside of the front and rear covers 14 and 16 includes a soft foam rubber or the like for giving the carrier member 12 added body and providing comfort when the member 12 is resting or riding against the side of the fisherman.

Should the fisherman wish to access the angled pockets 24 for changing fishing bait, he can move a fishing rod 38 and reel 39 from his right hand to his left hand. He can then use the right hand to reach into a selected pocket 24 with the pockets 24 angled properly for quick access to the fish bait containers stored therein. The angled pockets 24 includes flexible covers 41 with loop fasteners 20 for engaging hook fasteners 18 attached to the outside 22 of the front cover 14. The upper angled pocket 24 in this drawing is shown with its cover 41 in an open position.

In FIG. 2, another perspective view of the carrier 10 is illustrated with the carrier member 12 in an open position. The front cover 14 is shown unfolded from the rear cover 16 and illustrating the telescoping rod 38 and reel 39 received on top of a lower fold portion 40. The lower fold portion 40 is integrally formed between the front cover 14 and the rear cover 16. The telescoping rod 38 is shown in this drawing in a retracted position for receipt along the length of the fold portion 40. The reel 39 is shown received in a space 42 between a pair of large storage pockets 44 attached to an inside 46 of the rear cover 16. The large storage pockets 44 are used for storing a fishing lure box and similar containers. The large storage pockets 44 also having openings in the top thereof with the openings parallel to the horizontal when the combination carrier is held upright.

The front cover 14 of the carrier member 12 also includes an inside 48 having additional large storage pockets 44 for holding miscellaneous fishing items. In this drawing, the inside 48 of the front cover 14 is shown having strips of the loop fasteners 20 along the length of its three sides as shown. Also, the inside 46 of the rear cover 16 is shown having strips of the hook fasteners 18 along the length of its three sides for releasably engaging strips of the loops fasteners 20 along the length of its three sides on the inside of the front cover when the front cover 14 is folded and indexed next to the rear cover 16 as shown in FIGS. 1, 1A, 3 and 4. While the hook and loop fasteners 18 and 20 are shown as a primary way of securing the front cover 14 to the rear cover 16, snaps and other types of fasteners can also be used equally well without departing from the spirit and scope of the invention.

Further, the combinations carrier 10 includes a removable rod bag 50 having an open end 51 with one side of the open end having hook fasteners 18 and the other side of the open end having loop fasteners 20. The rod bag 50 is used for receipt around a portion of a rod having a fixed length. The removable rod bag 50 is shown in a folded position in this drawing.

In FIG. 3, a perspective view of the back of the rear cover 16 is shown with the front cover 14 releaseably attached to the rear cover 16 using the hook and loop fasteners 18 and 20. In this drawing, the rear cover 16 is shown with an outside 52 having a plurality of large storage pockets 54 for holding a first aid kit, insect repellant, pliers and other large items used when fishing.

In FIG. 4, another perspective view of the carrier member 12 is illustrated with the sides of the open end 51 of the removable rod bag 50 releaseably attached to one end of the fold portion 40. One side of the open end 56 includes hook fasteners 18 and an opposite side of the one end includes loop fasteners 20. The hook and loop fasteners 18 and 20 are used for engaging a portion of the hook and loop fasteners 18 and 20 at end of the fold portion 40. The rod bag 50 is used for receiving a portion of a fishing rod when transporting the fishing rod to and from a fishing location. Obviously, the rod bag 50 is only required when the rod has a fixed length and is not a telescopic type rod 38 as shown in FIGS. 1A and 2.

While the invention has been particularly shown, described and illustrated in detail with reference to the preferred embodiments and modifications thereof, it should be understood by those skilled in the art that equivalent changes in form and detail may be made therein without departing from the true spirit and scope of the invention as claimed except as precluded by the prior art.

The embodiments of the invention for which as exclusive privilege and property right is claimed are defined as follows:

1. A combination carrier used for holding a fishing rod and reel, fishing tackle and miscellaneous fishing supplies therein, the combination carrier comprising:
a flexible fabric carrier member having a front cover integrally attached to a rear cover, sides of said front cover releasably attached to said rear cover when indexed thereon; and
a plurality of pockets, said pockets attached to said front and rear covers, said pockets adapted for holding the fishing tackle and fishing supplies therein.

2. The combination carrier as described in claim 1 wherein said front cover is releasably attached to said rear cover using hook and loop fasteners.

3. The combination carrier as described in claim 1 wherein said front cover is releasably attached to said rear cover using snaps.

4. The combination carrier as described in claim 1 wherein said front cover is releasably attached to said rear cover using a zipper.

5. The combination carrier as described in claim 1 further including a lower fold portion, said lower fold portion integrally attached to said front and rear covers and therebetween, said lower fold portion adapted for receiving the fishing rod thereon when said front cover is attached to said rear cover.

6. The combination carrier as described in claim 1 wherein said front and rear covers include an inside and an outside, the inside and outside of said front and rear covers having said pockets mounted thereon.

7. The combination carrier as described in claim 1 further including a hand and shoulder strap attached to said fabric carrier member.

8. The combination carrier as described in claim 1 further including a removable rod bag having an open end, sides of the open end of said rod bag releasably attached to a portion of said carrier member, said rod bag adapted for receiving a portion of the fishing rod therein.

9. A combination carrier used for holding a fishing rod and reel, fishing tackle and miscellaneous fishing supplies therein, the combination carrier comprising:
a flexible fabric carrier member having a front cover integrally attached to a lower fold portion, said lower fold portion integrally attached to a rear cover, sides of said front cover releasably attached to said rear cover when indexed thereon, said lower fold portion adapted for receiving the fishing rod thereon when said front cover is attached to said rear cover; and
a pair of storage pockets attached to an inside of said rear cover with a space therebetween, the space adapted for receiving the reel when said front cover is attached to said rear cover, said storage pockets adapted for holding the fishing tackle and fishing supplies therein.

10. The combination carrier as described in claim 9 wherein said front cover includes strips of loop fasteners attached along sides of an inside of said front cover and said rear cover includes strips of hook fasteners attached along sides of an inside of said rear cover, said strips of loop fasteners used for releasable attachment to said strips of hook fasteners and holding said front cover next to said rear cover.

11. The combination carrier as described in claim 9 further including an adjustable hand and shoulder strap having opposite ends attached to a top portion of said carrier member.

12. The combination carrier as described in claim 10 further including a removable rod bag having an open end with hook fasteners attached to one side of the open end and loop fasteners attached to an opposite side of the open end, said rod bag releasably attached to said strips of hook and loop fasteners attached to the inside of said front and rear covers.

13. A combination carrier used for holding a fishing rod and reel, fishing tackle and miscellaneous fishing supplies therein, the combination carrier comprising:
a flexible fabric carrier member having a front cover integrally attached to a lower fold portion, said lower fold portion integrally attached to a rear cover, sides of said front cover releasably attached to said rear cover when indexed thereon, said lower fold portion adapted for receiving the fishing rod thereon when said front cover is attached to said rear cover;
a plurality of pockets attached to an inside and an outside of said front and rear covers, said pockets adapted for holding the fishing tackle and fishing supplies therein; and
a removable rod bag, said rod bag having an open end, sides of the open end of said rod bag releasably attached to a portion of said carrier member, said rod bag adapted for receiving a portion of the fishing rod therein when said lower fold portion receives the fishing rod thereon.

14. The combination carrier as described in claim 13 wherein said front cover includes strips of loop fasteners attached along three sides of an inside of said front cover and said rear cover includes strips of hook fasteners attached along three sides of an inside of said rear cover, said strips of loop fasteners used for releasable attachment to said strips of hook fasteners and holding said front cover next to said rear cover.

15. The combination carrier as described in claim 13 further including an adjustable hand and shoulder strap having opposite ends attached to a top portion of said rear cover, said adjustable hand and shoulder strap used for holding said carrier member when fishing and when transporting said carrier member to and from a fishing location.
